(19) United States
(12) Patent Application Publication
(10) Pub. No.: US 2011/0241597 A1
(43) Pub. Date: Oct. 6, 2011

(54) H-BRIDGE DRIVE CIRCUIT FOR STEP MOTOR CONTROL

(75) Inventors: Zhengmao Zhu, San Jose, CA (US); Jongwon Kim, Sunnyvale, CA (US); Kayvan Abbassian, Pleasanton, CA (US)

(73) Assignee: LIN ENGINEERING, Santa Clara, CA (US)

(21) Appl. No.: 12/750,454

(22) Filed: Mar. 30, 2010

(51) Int. Cl. H02P 8/14

(52) U.S. Cl. 318/696

(57) ABSTRACT

A drive circuit for step motors with bifilar windings is provided in which both parallel and series winding configurations for the stator coils are selectable by a motor controller based on the motor speed. For low speeds a series configuration is selected, while for higher speeds a parallel configuration is selected. Dynamic torque is optimized by the selection for more efficient motor operation with less drive current.

### TECHNICAL FIELD

The present invention relates to step motor controllers and drivers for directing the switching of current among the several stator coils in a cycle of phases, and relates in particular to H-bridge drive circuits and associated winding configurations for obtaining adequate efficiency and motor torque for various motor speeds.

### BACKGROUND ART

Step motors are used in a wide variety of applications that require precise motion control, such as printers, scanners, x-y tables, turntables, tape and disk drive systems, security cameras and other optical equipment, robotics, electro-mechanical motion control systems, CNC (computer-numeric-control) machine tools, dispensers, injector pumps and other medical equipment. A wide variety of step motor designs and drive circuitry have been introduced in order to achieve specific performance goals, such as reduced noise and vibration, increased resolution and accuracy of motor positions, adequate holding torque, and efficient power usage over a range of motor speeds. These different performance factors are met in a variety of ways by the step motor designs and their drive circuitry, often involving tradeoffs and compromises.

Some existing applications require high torque at both low speeds and high speeds. Typically, however, the windings in a step motor and the drive circuitry for applying power to such windings can be optimized only for one or the other speed. Only rarely can a motor design be made suitable for both low- and high-speed operation, and these designs usually fail to get the same or better performance at either speed than a motor design that has been optimized for a specific speed.

For example, step motors can have bifilar windings that are connected either in series or parallel. If the motor connections are such that the windings are driven in series, such a motor is optimized for better low-speed performance; but if instead the motor connections are such that the windings are driven in parallel, the motor is optimized for better high-speed performance. U.S. Pat. No. 6,597,077 provides a hybrid “T-connection” of the bifilar step motor windings which optimizes the motor for better mid-speed performance than either the series or parallel connections.

Because no single motor and driver design exists that can adequately integrate both low-speed and high-speed performance for optimum results, two motors are often required in those applications that must operate with high efficiency over a wide range of speeds, each motor optimized for a different speed range. A secondary shaft or mechanical coupling is required when two motors are used and two electronic systems are also required. The integration of such two-motor systems is complex, and costs are at least doubled over that of a single-motor system.

### SUMMARY DISCLOSURE

A single step motor is driven in accord with the present invention by a unique H-bridge drive circuit that provides a choice of both series and parallel connections to the same bifilar windings and switches between the two types of connections according to the motor speed. When a slow motor speed is required, the H-bridge drive circuit in accord with the present invention connects the bifilar windings in series for optimum performance at that slow speed, and when a high motor speed is required from that same motor, the H-bridge drive circuit connects the same bifilar windings in parallel for optimum performance at that high speed also. The H-bridge drive circuit has a first set of transistors driven by configuration signals and functioning as series/parallel winding configuration transistors, and also has a second set of transistors driven by motor phase signals and connected to step motor coils, where the first set of transistors are arranged to connect a power supply in either series or parallel to the coils through the second set of transistors. Both series and parallel configurations share the power FETs in the H-bridge drive circuit. The switching between winding configurations by the drive circuit can thus provide improved performance of a single step motor design over a wider range of operational motor speeds. This eliminates the requirement for multiple distinct motors and likewise for multiple drive electronics. A single motor system is simpler to implement and costs are significantly reduced.

A step motor winding configuration system comprises a step motor having bifilar windings that are selectively connectable either in a series winding configuration or in a parallel winding configuration, a step motor driver circuit that is arranged to make a selected winding configuration in response to received configuration signals, a motor speed detector, and a controller responsive to a detected motor speed to select one of the series and parallel winding configurations and provide corresponding configuration signals to the driver circuit. In particular, a series configuration is selected when motor speed is slower than some designated transition speed, but a parallel configuration is selected when motor speed is faster than the designated transition speed. Additionally, there could be two different transition speeds for switching from series to parallel configurations when motor speed increases past a first transition speed and for switching from parallel to series configurations when motor speed decreases to below a second transition speed. Motor speed may be detected via the motor steps (drive phases) provided to motor through the driver circuit, using a counter to count number of steps per some clock period and then compare that count to transition speeds expressed also in steps per clock period.

Hence, a method of driving the step motor includes detecting a speed of the motor as it is driven by the driver circuit, and providing configuration signals in accord with the detected motor speed so as to connect the motor's bifilar windings in series for low motor speeds less than a designated transition speed and in parallel for high motor speeds greater than a designated transition speed, where the designated speed could be different for series-to-parallel configuration switching with increasing motor speeds versus parallel-to-series configuration switching with decreasing motor speeds.

### BRIEF DESCRIPTION OF THE DRAWINGS

FIG. 1 is a circuit diagram of an embodiment of an H-bridge drive circuit for switching between series and parallel winding connections in accord with the present invention.

FIGS. 2A and 2B are circuit diagrams as in the embodiment of FIG. 1, illustrating the current flow from windings A to −B and from B to −A, respectively, for a parallel mode of operation.

FIGS. 3A and 3B are circuit diagrams as in the embodiment of FIG. 1, illustrating the current flow from windings A to −B and from B to −A, respectively, for a series mode of operation.

FIG. 4 is a graph of dynamic torque for various motor speeds, comparing the series and parallel connections of prior step motors with the switched series-parallel (SP) connection obtained by the present invention.

FIGS. 5A through 5C are a plan of a step motor stator with a representation of it windings, and a pair of corresponding winding connection diagrams for the series and parallel connections.

FIG. 6 is a block schematic of a winding configuration controller for step motors using the drive circuit of FIG. 1.

### DETAILED DESCRIPTION

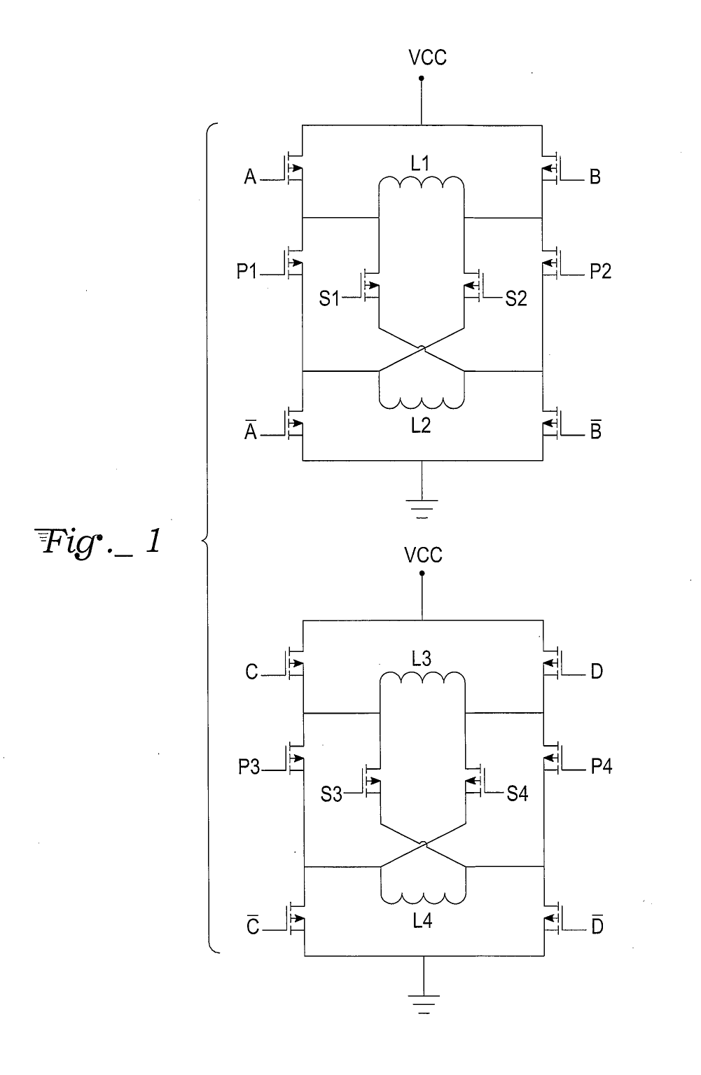

With reference to FIG. 1, an H-bridge drive circuit for a step motor with bifilar windings has a plurality of identical drive sub-circuits, one for each of the pairs of stator coils of the bifilar windings. In the case where two sets of stator poles are separately wound with pairs of stator coils, the drive circuit has two identical parts or sub-circuits, one for a first pair of step motor stator coils, L1 and L2, with their associated set of driver connections, A, −A, B, and −B, and the other for a second pair of step motor stator coils, L3 and L4, with their associated set of driver connections, C, −C, D and −D. Both parts have control inputs S1, S2, and P for selectively establishing serial or parallel connections of the step motor stator coils.

The first part of the drive circuit includes a first transistor A coupled to a first power supply terminal Vcc and to a first terminal of a first step motor stator coil L1. A second transistor B is coupled to the first power supply terminal Vcc and to a second terminal of the first step motor stator coil L2. A third transistor −A is coupled to a second power supply terminal GND and to a first terminal of a second step motor stator coil L2. A fourth transistor −B is coupled to the second power supply terminal GND and to a second terminal of the second step motor stator coil L2. These transistors are power field-effect transistors (FETs) designed to carry adequate current to the respective stator coils L1 and L2. A motor controller controls the commutation or switching on and off of these power transistors A, −A, B and −B in accord with known step motor drive techniques. The motor can also be operated in a micro-stepping mode, in which current through the power transistors is not simply on/off, but operated in the “linear” region, allowing a varying gradation of partial current flows through the transistors and then through the coils.

The first part of the drive circuit also includes a set of configuration control transistors, S1, S2, P1, and P2, which are also power FETs. These determine whether the current drives the pairs of stator coils in the bifilar winding in parallel or in series. A first serial connection transistor S1 is coupled to the first terminal of the first step motor stator coil L1 and to the second terminal of the second step motor stator coil L2 between the first and fourth transistors A and −B. A second serial connection transistor S2 is coupled to the second terminal of the first step motor stator coil L1 and to the first terminal of the second step motor stator coil L2 between the second and third transistors B and −A. A first parallel connection transistor P1 is coupled to the first terminals of both the first and second step motor stator coils L1 and L2 between the first and third transistors A and −A. A second parallel connection transistor P2 is coupled to the second terminals of both the first and second step motor stator coils L1 and L2 between the second and fourth transistors B and −B.

Likewise, a second part or sub-circuit of the drive circuit has power transistors C, −C, D and −D, together with configuration transistors S3, S4, P3 and P4, coupled to another pair of stator coils L3 and L4 in exactly the same manner as the first sub-circuit.

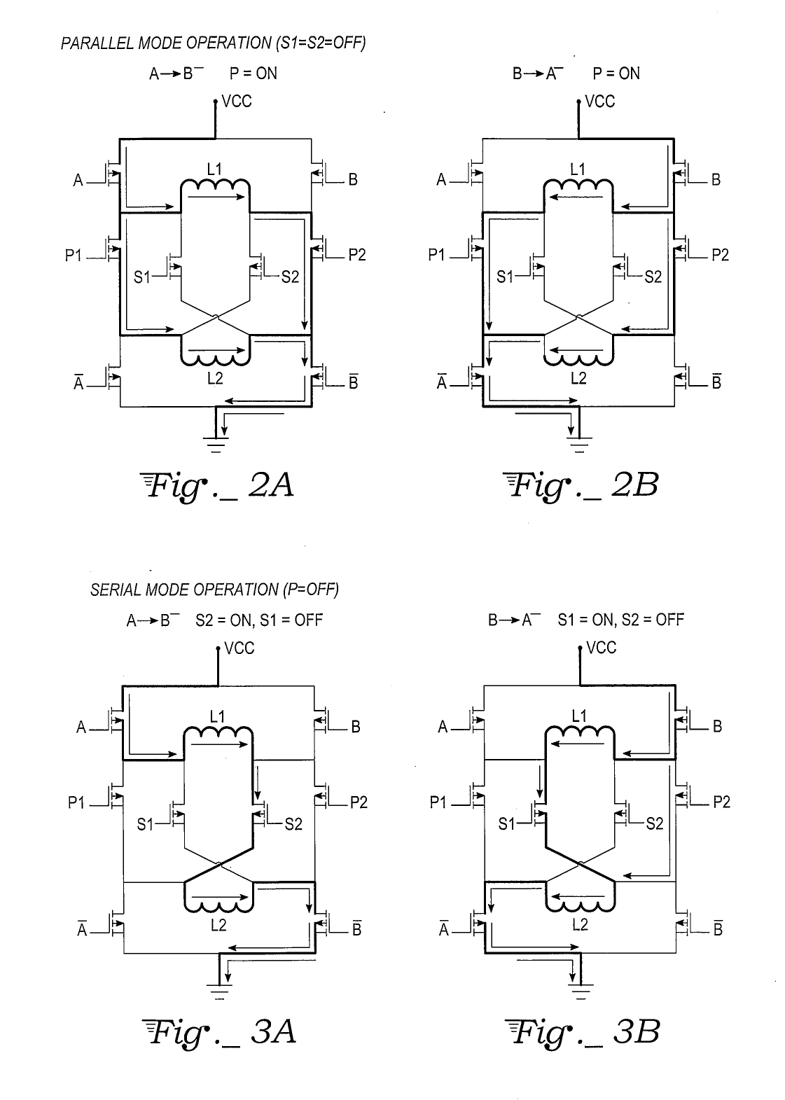

With reference to FIGS. 2A and 2B, in a parallel mode of operation of the step motor, all parallel connection transistors P1 through P4 are turned ON, while all series connection transistors S1 through S4 are turned OFF. The figures show the current paths through the first part or sub-circuit of the drive circuit for both the A→−B and B→−A commutations. The current paths through second sub-circuit for both the C→−D and D→−C commutations are equivalent.

As seen in FIG. 2A for the A→−B commutation, drive current flows through the first coil L1, from the power supply Vcc through power transistor A, then the coil L1, finally through the parallel connection transistor P2 and power transistor −B to the ground terminal GND. Drive current flows also through the second coil L2, from the power supply Vcc through power transistor A and the parallel connection transistor P1, then the coil L2, finally through the power transistor −B to the ground terminal GND. Thus, current flows through both coils L1 and L2 of the bifilar windings in parallel.

Likewise, as seen in FIG. 2B for the B→−A commutation, drive current flows through the first coil L1, from the power supply Vcc through power transistor B, then the coil L1, finally through the parallel connection transistor P1 and power transistor −A to the ground terminal GND. Drive current flows also through the second coil L2, from the power supply Vcc through power transistor B and the parallel connection transistor P1, then the coil L2, finally through power transistor −A to the ground terminal GND. Thus again, current flows through both coils L1 and L2 of the bifilar windings in parallel, but in the opposite directions from the A→−B commutation.

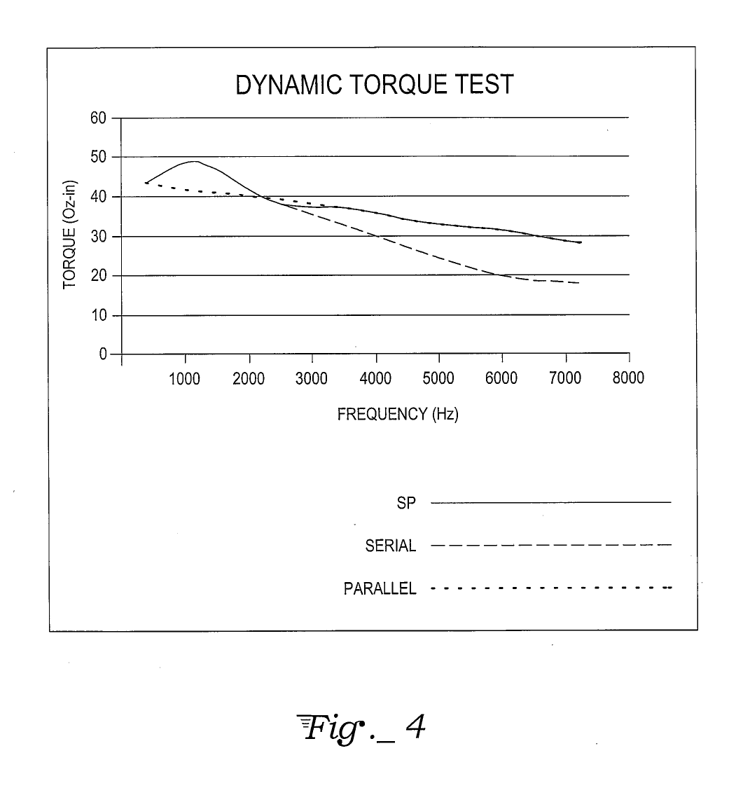

With reference to FIGS. 3A and 3B, in a serial mode of operation of the step motor all parallel connection transistors P1 through P4 are turned OFF, while all series connection transistors S1 through S4 are commutated ON/OFF. The figures show the current paths through the first part or sub-circuit of the drive circuit for both the A→−B and B→−A commutations. The current paths through second sub-circuit for both the C→−D and D→−C commutations are equivalent.

As seen in FIG. 3A for the A→−B commutation, drive current flows through the first and second coils L1 and L2, from the power supply Vcc through power transistor A, then the coil L1, the series connection transistor S2 (which is ON, while S1 is OFF), then coil L2, and finally through power transistor −B to the ground terminal GND. Thus, current flows through coils L1 and L2 of the bifilar windings in series.

As seen in FIG. 3B for the B→−A commutation, drive current flows through the first and second coils L1 and L2, from the power supply Vcc through power transistor B, then the coil L1, the series connection transistor S1 (which is ON, while S2 is OFF), then coil L2, and finally through power transistor −A to the ground terminal GND. Thus again, current flows through coils L1 and L2 of the bifilar windings in series, but in the opposite direction from the A→−B commutation.

Transistors A and −B are commutated together (both ON or both OFF, as are transistors B and −A, transistors C and −D, and transistors D and −C. In the parallel configuration, all of the parallel connection transistors are ON, while all of the series connection transistors are OFF. In the series configuration, all of the parallel transistors are OFF, while the series connection transistors are commutated with the other power transistors. Transistor S1 is commutated with A and −B (all ON or all OFF), transistor S2 is commutated with B and −A, transistor S3 of the second sub-circuit is commutated with C and −D, and transistor S4 is commutated with D and −C. A motor controller governs the commutation, simply making sure that all transistors that need to be commutated together are commonly connected. If microstepping is used, any one or more (typically all) of the power transistors may be partially turned on or off in gradations according to commonly established techniques. The motor controller also monitors the motor speed to determine whether to use the parallel or series mode of operation. This is a simple modification to existing motor controllers.

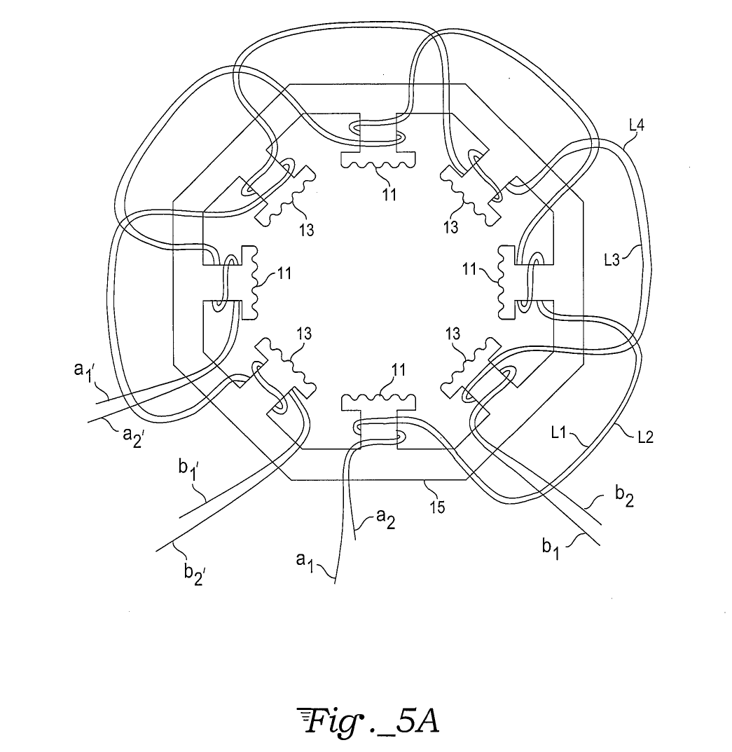

The graph in FIG. 4 displays dynamic torque (in oz-in) for series, parallel, and series-parallel (SP) connections of step motor windings. The particular values are dependent upon the particular model of step motor, but the typical values presented here are representative of the general trends. The SP connection is the curve demonstrating the present technology.

| | | Serial | Parallel | SP |
|---|---|---|---|---|
| | | Connection | Connection | Connection |
| Speed | Frequency | Torque | Torque | Torque |
| (Rev/Sec) | (Hz) | (Oz-In) | (Oz-In) | (Oz-In) |
| 1 | 400 | 43.9 | 43.8 | 43.9 |
| 3 | 1200 | 48.8 | 41.5 | 48.8 |
| 6 | 2400 | 38.8 | 39.45 | 38.8 |
| 9 | 3600 | 32.25 | 36.95 | 36.95 |
| 12 | 4800 | 25.4 | 33.45 | 33.45 |
| 15 | 6000 | 19.8 | 31.25 | 31.25 |
| 18 | 7200 | 17.8 | 28.25 | 28.25 |

A motor controller drives this motor embodiment in the series mode of operation whenever the motor speed is slower than 6 revolutions per second (frequency 2400 Hz or less), and would drive the motor in the parallel mode whenever the motor speed is faster than that, thereby providing optimum torque for nearly all speeds. The transition point for switching between series and parallel mode need not coincide exactly with the crossover in dynamic torques for the two modes, but can be chosen at a convenient point for ease of motor speed calculation by the motor controller.

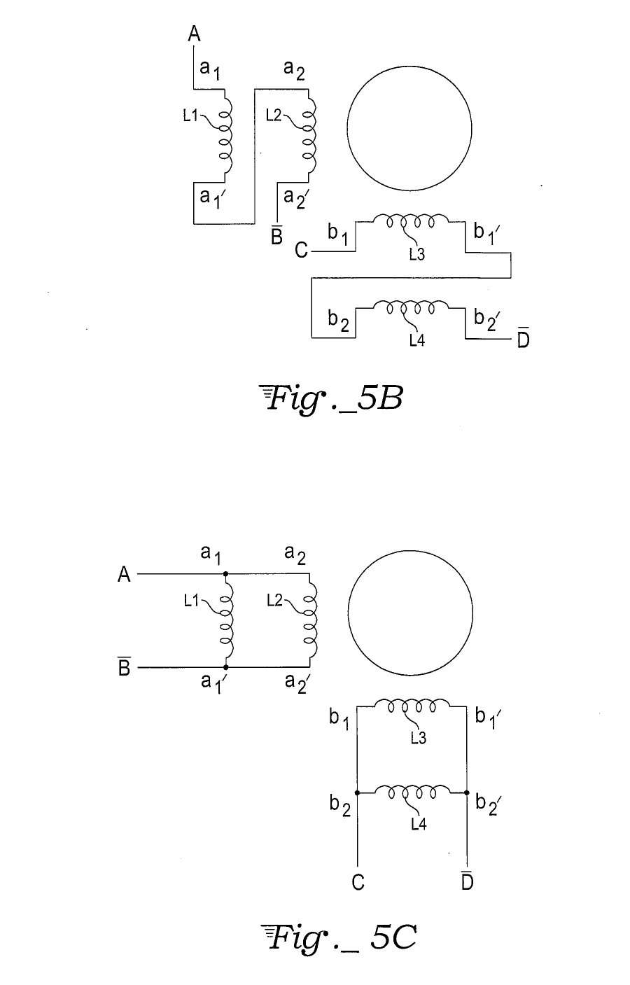

With reference to FIG. 5A, the stator of a typical step motor is illustrated with a representation of the bifilar stator coil windings. Electrically, four stator coils L1 through L4 are wound around the stator poles 11 and 13 in a specified manner. A bifilar winding pattern is used, meaning that the stator coils are wound around the stator poles in pairs. Thus, first and second stator coils L1 and L2 are paired throughout the winding with a first set of stator poles 11, and likewise third and fourth stator coils L3 and L4 are paired throughout the winding with a second set of stator poles 13 interleaved with the first. Each stator coil is wound around every other stator pole in alternating clockwise and counterclockwise directions. The ends of the stator coil wires are designated as a1 and a1′ for L1, a2 and a2′ for L2, b1 and b1′ for L3 and b2 and b2′ for L4. These coil ends are connected to the parts of the H-bridge drive circuit of FIG. 1.

FIG. 5B shows a series connection for the stator coils. The end a1′ of the first coil L1 connects to the end a2 of the second coil L2 so that the coils L1 and L2 are connected in series. Likewise, the end b1′ of third coil L3 connects to the end b2 of the fourth coil L4 so that the coils L3 and L4 are also connected in series. The ends a1 and a2′ are coupled to the power supply in the first sub-circuit part of the drive circuit (here, the A→−B commutation is illustrated). Likewise, the ends b1 and b2′ are coupled to the power supply in the second sub-circuit part of the drive circuit (here, the C→−D commutation is illustrated).

FIG. 5C shows a parallel connection for the stator coils. The ends a1 and a2 of the first and second coils are connected, as are the ends a1′ and a2′, so that drive current flows through both coils L1 and L2 in parallel. Again, the A→−B commutation for the drive circuit is illustrated. Likewise, the coils L3 and L4 are connected in parallel by the second part of the drive circuit.

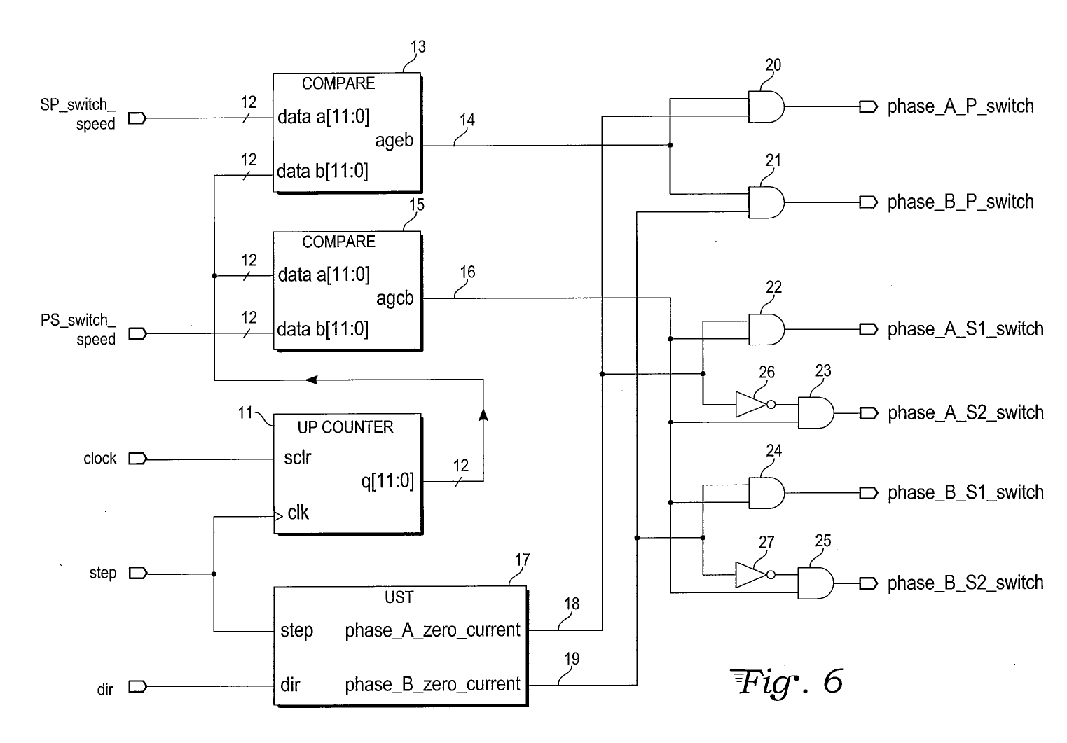

With reference to FIG. 6, a circuit that detects motor speed and compares it to one or more designated transition speeds provides corresponding configuration signals to the H-bridge driver circuit that controls the configuration of the motor. In the controller shown here, an up counter 11 receives a clock signal on its shift clear input and a step signal on its clock input. Hence, the counter 11 counts the number of step signals per clock period and shifts out the count q[11:0] at the end of each clock period.

The count is supplied to one or more comparators, here two in number, 13 and 15, one of the data inputs. The comparator(s) also receive a comparison value on their respective data a[11:0] inputs representing transition speeds, also in terms of steps per clock period. In: this example, the first comparator 13 compares a series-to-parallel transition value, SP_switch_speed, with the detected motor speed from the counter 11 and generates an output 14 according to whether the motor speed has exceeded that transition value. The second comparator 15 compares the detected motor speed from the counter 11 with a parallel-to-series transition value, PS_switch_speed, and generates an output 16 according to whether the motor speed has fall below that transition value.

The controller also includes a micro-stepping translator (UST) 17, with inputs from the step signal and a direction signal. The UST 17 picks up the zero current level in each coil (phases A and B) and outputs corresponding signals that serve to inhibit switching of configurations outside of such zero current situations. This prevents the MOSFETs from being damaged by untimely transitions.

A set of logic gates (ANDs 20-25 and inverters 26-27) combines the comparator outputs 14 and 16 with the zero-current detection signals 18 and 19 to produce the configuration signals. The signal phase_A_P_switch couples to the P1 and P3 inputs of the H-bridge circuit of FIG. 1. The signal phase_B_switch couples to the P2 and P4 inputs of the H-bridge circuit. The signal phase_A_S1_switch couples to the S1 input of the H-bridge circuit. The signal phase_A_S2_switch couples to the S2 input of the H-bridge circuit. The signal phase_B_S1_switch couples to the S3 input of the H-bridge circuit. The signal phase_B_S2_switch couples to the S4 input of the H-bridge circuit.

The controller circuit is a typical example, but other modifications could be made, such as use of a single comparator with a single transition speed value, detection of speed from a physical sensor in the motor itself, and use of active low comparator outputs with NOR gates instead of the active high outputs with AND gates shown here.

1. A step motor winding configuration system, comprising:
a step motor having bifilar windings selectively connectable in a series winding configuration and in a parallel winding configuration;
a step motor driver circuit arranged to make a selected winding configuration in response to received configuration signals;
a motor speed detector; and
a controller responsive to a detected motor speed to select one of the series and parallel winding configurations and provide corresponding configuration signals to the step motor driver circuit.

2. The system as in claim 1, wherein the controller provides configuration signals corresponding to a series winding configuration for motor speeds slower than a designated transition speed and provides configuration signals corresponding to a parallel winding configuration for motor speeds faster than the designated transition speed.

3. The system as in claim 1, wherein the controller has a first transition speed for switching from a series to a parallel winding configuration as motor speed increases and a second transition speed for switching from a parallel to a series winding configuration as motor speed decreases.

4. The system as in claim 1, wherein the speed detector comprises a counter of motor steps that are provided to the step motor through the driver circuit, a number of steps counted per each clock period being output to a comparator receiving a transition speed value in steps per clock period.

5. The system as in claim 1, wherein the step motor driver circuit comprises an H-bridge drive circuit having a first set of transistors driven by the configuration signals and a second set of transistors driven by motor phase signals and connected to step motor coils, the first set of transistors arranged to provide a series or parallel connection of a power supply to the coils through the second set of transistors.

6. An H-bridge drive circuit for a step motor with bifilar windings, a first pair of stator coils of the bifilar windings being wound around a first set of stator poles of the step motor and a second pair of stator coils of the bifilar windings being wound around a second set of stator poles of the step motor, each pair of stator coils associated with a particular set of stator poles being driven with electrical current supplied through a corresponding one of a plurality of identical drive sub-circuits, one sub-circuit per pair of stator coils, each sub-circuit of the H-bridge drive circuit comprises:
a first transistor A coupled to a first power supply terminal Vcc and to a first terminal of a first step motor coil L1;
a second transistor B coupled to the first power supply terminal Vcc and to a second terminal of the first step motor coil L1;
a third transistor A′ coupled to a second power supply terminal GND and to a first terminal of a second step motor coil L2;
a fourth transistor B′ coupled to the second power supply terminal GND and to a second terminal of the second motor coil L2;
a first serial connection transistor S1 coupled to the first terminal of the first step motor coil L1 and to the second terminal of the second step motor coil L2 between the first and fourth transistors A and B′;
a second serial connection transistor S2 coupled to the second terminal of the first step motor coil L1 and to the first terminal of the second step motor coil L2 between the second and third transistors B and A′;
a first parallel connection transistor P1 coupled to the first terminal of the first step motor coil L1 and to the first terminal of the second step motor coil L2 between the first and third transistors A and A′; and
a second parallel connection transistor P2 coupled to the second terminal of the first step motor coil L1 and to the second terminal of the second step motor coil L2 between the second and fourth transistors B and B′.

7. A method of driving a step motor, comprising:
detecting a motor speed of a step motor as the motor is driven by a step motor driver circuit, the step motor having bifilar windings connectable by the driver circuit in a selected one of a series winding configuration and a parallel winding configuration; and
providing configuration signals to the driver circuit so as to control selection of winding configuration in accord with detected motor speed, wherein a series winding configuration is selected whenever detected motor speed is less than a designated transition speed and a parallel winding configuration is selected whenever detected motor speed is greater than a designated transition speed.

8. The method as in claim 7, wherein configuration signals are switched from a series to a parallel winding configuration at a first transition speed as motor speed increases and for switched from a parallel to a series winding configuration at a second transition speed as motor speed decreases.

9. The method as in claim 7, wherein motor speed is detected by counting a number of motor steps per a clock period as provided to the driver circuit, and comparing the counted number to a transition speed value given in steps per clock period.

10. The method as in claim 7, wherein winding configuration of the step motor is controlled by an H-bridge-type driver circuit having a first set of transistors driven by the configuration signals and a second set of transistors driven by motor phase signals and connected to step motor coils, the first set of transistors arranged to select a series or parallel connection of a power supply to the coils through the second set of transistors.
